(19) United States
(12) Patent Application Publication
(10) Pub. No.: US 2014/0172839 A1
(43) Pub. Date: Jun. 19, 2014

(54) Method and System of Identifying Replacements for Unavailable Web Pages

(71) Applicants: Stefan Christoph, Uster (CH); Benjamin Liebald, Zurich (CH); Mihai Stroe, Zurich (CH); Thomas Hofmann, Zollikon (CH)

(72) Inventors: Stefan Christoph, Uster (CH); Benjamin Liebald, Zurich (CH); Mihai Stroe, Zurich (CH); Thomas Hofmann, Zollikon (CH)

(21) Appl. No.: 12/050,065

(22) Filed: Mar. 17, 2008

Related U.S. Application Data
(60) Provisional application No. 61/029,282, filed on Feb. 15, 2008.

(51) Int. Cl. G06F 17/30

(52) U.S. Cl. 707/723; 707/E17.032; 707/726; 707/737

(57) ABSTRACT

A method of suggesting replacements for unavailable web pages is performed at a server system separate from a client system. A web page is identified. For documents in a collection of web pages, respective overlaps of content in the web page and the documents are determined based on stored information about content in the web page and the documents. One or more of the documents that have overlaps that satisfy a first criterion are selected. A request for a replacement for the web page is received from the client system and replacement web page information is provided to the client system. The replacement web page information is selected from the set consisting of A) one or more links to the one or more selected documents, B) a redirect to one of the one or more selected documents, and C) one of the one or more selected documents.

### RELATED APPLICATIONS

This application claims priority under 35 U.S.C. 119 to U.S. Provisional Application 61/029,282, “Method and System of Identifying Replacements for Unavailable Web Pages,” filed Feb. 15, 2008, which is hereby incorporated by reference in its entirety.

### TECHNICAL FIELD

The disclosed embodiments relate generally to web browsing, and more particularly, to identifying replacements for unavailable web pages.

### BACKGROUND

Previously accessible web pages sometimes become unavailable and thus inaccessible to users browsing the web. For example, a web page may be moved from a first URL (uniform resource locator) to a second URL, causing a user who enters the first URL into a web browser or who selects a link to the first URL to be unable to access the web page. In other examples, a web page could be taken down from the host on which it previously was stored or the host itself could become inaccessible.

A request for an unavailable web page, such as an http request generated by a web browser, may result in a number of types of error notifications. For example, a 404 error results if a host associated with the web page is accessible but is unable to find the web page or is configured not to fulfill the request and not to reveal why. A DNS error results if the host itself is inaccessible. A 403 error results if the request is forbidden. A request may time out if the host does not respond within a specified time. Various other types of error are possible.

Regardless of the type of error, the unavailability of the requested web page frustrates the user's attempt to access content previously provided by the web page. Accordingly, there is a need for a way to suggest replacements for unavailable web pages, wherein the suggested replacements have overlapping content with the unavailable web page that may be of interest to the user.

### SUMMARY

In some embodiments, a method of suggesting replacements for unavailable web pages is performed at a server system separate from a client system. In the method, a web page is identified. For respective documents in a collection of web pages, respective overlaps of content in the web page and the respective documents are determined based on stored information about content in the web page and the respective documents. One or more of the respective documents that have overlaps that satisfy a first criterion are selected. A request for a replacement for the web page is received from the client system. In response to the request, replacement web page information is provided to the client system. The replacement web page information is selected from the set consisting of A) one or more links to the one or more selected documents, B) a redirect to one of the one or more selected documents, and C) one of the one or more selected documents.

In some embodiments, a server system includes one or more processors and memory storing one or more programs to be executed by the one or more processors. The one or more programs include: instructions to identify a web page; instructions to determine, for respective documents in a collection of web pages, based on stored information about content in the web page and the respective documents, respective overlaps of content in the web page and the respective documents; and instructions to select one or more of the respective documents having overlaps that satisfy a first criterion. The one or more programs also include: instructions to receive from the client system a request for a replacement for the web page; and instructions to provide to the client system, in response to the request, replacement web page information selected from the set consisting of A) one or more links to the one or more selected documents, B) a redirect to one of the one or more selected documents, and C) one of the one or more selected documents.

In some embodiments, a computer readable storage medium stores one or more programs to be executed by one or more processors at a server system. The one or more programs include: instructions to identify a web page; instructions to determine, for respective documents in a collection of web pages, based on stored information about content in the web page and the respective documents, respective overlaps of content in the web page and the respective documents; and instructions to select one or more of the respective documents having overlaps that satisfy a first criterion. The one or more programs also include: instructions to receive from the client system a request for a replacement for the web page; and instructions to provide to the client system, in response to the request, replacement web page information selected from the set consisting of A) one or more links to the one or more selected documents, B) a redirect to one of the one or more selected documents, and C) one of the one or more selected documents.

In some embodiments, a method of suggesting replacements for unavailable web pages is performed at a client system separate from a server system. In the method, notification of an unavailable web page is received. A request for replacement web page information is sent to the server system. In response, replacement web page information is received from the server system. The replacement web page information is selected from the set consisting of A) one or more links to one or more web pages having content overlap with the unavailable web page that satisfies a first criterion, B) a redirect to a web page having content overlap with the unavailable web page that satisfies the first criterion, and C) a web page having content overlap with the unavailable web page that satisfies the first criterion.

In some embodiments, a client system includes one or more processors and memory storing one or more programs to be executed by the one or more processors. The one or more programs include: instructions to receive notification of an unavailable web page; instructions to send to a server system a request upon receiving the notification; and instructions to receive replacement web page information from the server system. The replacement web page information is selected from the set consisting of A) one or more links to one or more web pages having content overlap with the unavailable web page that satisfies a first criterion, B) a redirect to a web page having content overlap with the unavailable web page that satisfies the first criterion, and C) a web page having content overlap with the unavailable web page that satisfies the first criterion.

In some embodiments, a computer readable storage medium stores one or more programs to be executed by one or more processors at a client system. The one or more programs include: instructions to receive notification of an unavailable web page; instructions to send to a server system a request upon receiving the notification; and instructions to receive replacement web page information from the server system. The replacement web page information is selected from the set consisting of A) one or more links to one or more web pages having content overlap with the unavailable web page that satisfies a first criterion, B) a redirect to a web page having content overlap with the unavailable web page that satisfies the first criterion, and C) a web page having content overlap with the unavailable web page that satisfies the first criterion.

### BRIEF DESCRIPTION OF THE DRAWINGS

FIG. 1 is a block diagram illustrating a networked web browsing environment in accordance with some embodiments.

FIGS. 2A-2C are schematic screenshots of a web browser user interface in accordance with some embodiments.

FIG. 3A is a flow diagram illustrating a method of suggesting replacements for unavailable web pages in accordance with some embodiments.

FIG. 3B is a flow diagram illustrating a method of using shingling to determine content overlaps in accordance with some embodiments.

FIG. 4 is a flow diagram illustrating a method of suggesting replacements for unavailable web pages in accordance with some embodiments.

FIGS. 5A-5C are diagrams illustrating data structures for web page shingling in accordance with some embodiments.

FIG. 6 is a block diagram illustrating a client computer in accordance with some embodiments.

FIG. 7 is a block diagram illustrating a server computer in accordance with some embodiments.

Like reference numerals refer to corresponding parts throughout the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

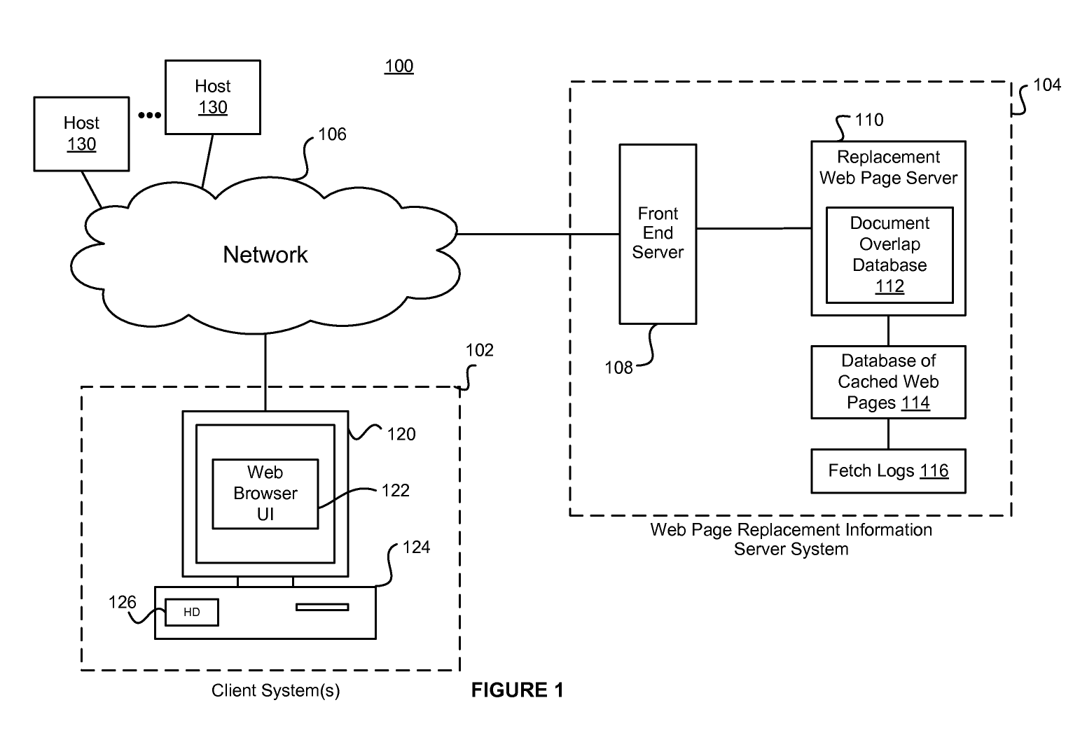

FIG. 1 is a block diagram illustrating a networked web browsing environment 100 in accordance with some embodiments. A client device or system 102 (hereinafter called the client system for ease of reference) is coupled to one or more hosts 130 and a web page replacement information server system 104 through a network 106. The network 106 may be any suitable wired and/or wireless network and may include a local area network (LAN), wide area network (WAN), the Internet, metropolitan area network (MAN), or any combination of such networks.

The client system 102 includes a computer 124 or computer controlled device, such as a personal digital assistant (PDA), cellular telephone, or the like. The computer 124 typically includes one or more processors (not shown); memory, which may include volatile memory (not shown) and non-volatile memory such as a hard disk drive 126; and a display 120. The computer 124 may also have input devices such as a keyboard and a mouse (not shown). The computer 124 may execute a web browser application to allow a user to access internet content, such as web pages. Execution of the web browsing application results in display of a web browser user interface (UI) 122 on the display 120. A user interfaces with the server system 104 and views content items at a client system or device 102.

The hosts 130 (e.g., web servers) provide web page content to client systems 102 in response to requests received through the network 106. In some embodiments, a request is an http request generated by a web browser application in response to user entry of a URL or user selection of a displayed link. A request from a client system 102 will fail, however, if the requested web page has become unavailable. Examples of unavailable web pages include, but are not limited to, web pages that have moved from an old URL to a new URL, web pages that are no longer accessible to their hosts 130, web pages stored on hosts 130 that have become inaccessible, and web pages that a user lacks permission to access.

In response to a failed request for a web page, the client system 102 may request replacement web page information from the server system 104. The server system 104 includes a front-end server 108 that retrieves replacement web page information from a replacement web page server 110 and provides an interface between the server system 104 and client systems 102. In some embodiments, the functions of the front-end server 108 and/or the replacement web page server 110 may be divided or allocated among two or more servers. In some embodiments, the replacement web page server 110 includes or is coupled to a document overlap database 112 that stores information regarding content overlap of various web pages.

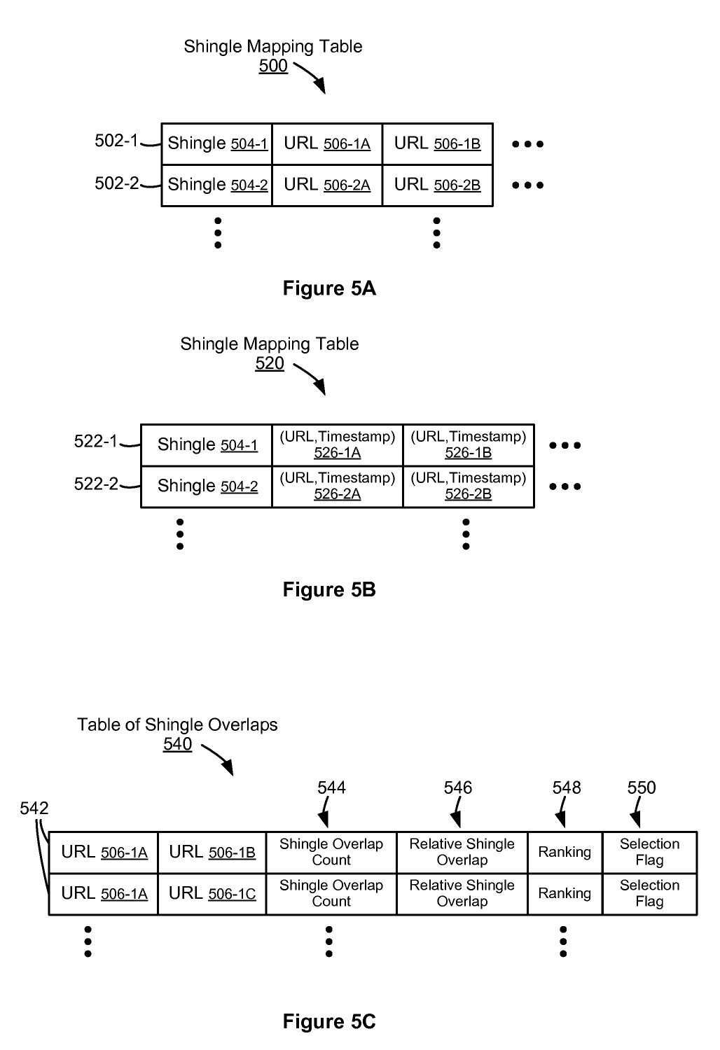

In some embodiments, the replacement web page server 110 is coupled to a database of cached web pages 1 14. The replacement web page server 110 compares respective cached web pages in the database 114 to determine the extent to which their contents overlap, and stores the results in the document overlap database 112. Examples of tables included within the document overlap database 112 are discussed further below with regard to FIGS. 5A-5C. In some embodiments, the database of cached web pages 114 is generated by a web crawler application that periodically fetches web pages. In some embodiments, the replacement web page server 110 is also coupled to one or more fetch logs 116 generated by the web crawler. The fetch logs 116 record when respective web pages were crawled and indicate whether or not the respective web pages were successfully crawled.

In response to a request from a client system 102 for replacement web page information for an unavailable web page, the replacement web page server 110 queries the document overlap database 112 to identify one or more documents (e.g., web pages) in the database 112 that have overlapping content with the unavailable web page. The server system 104 then transmits information regarding the one or more identified documents to the client system 102 that issued the request, for display in the web browser UI 122. For example, the server system 104 may transmit links to the one or more identified documents, and may additionally transmit snippets from the identified documents. Alternatively, the server system 104 may transmit a redirect to an identified document; the redirect instructs the client 102's web browser application to download the identified document from a corresponding host 130. In another example, the server system 104 may transmit a copy of an identified copy, such as a copy stored in the database of cached web pages 114.

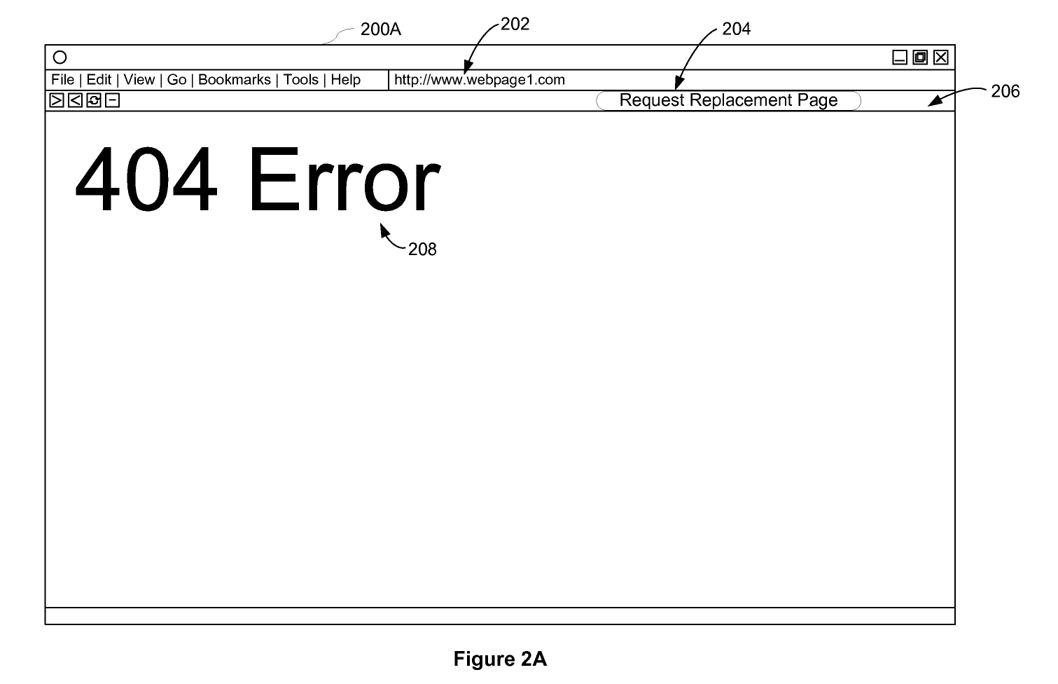

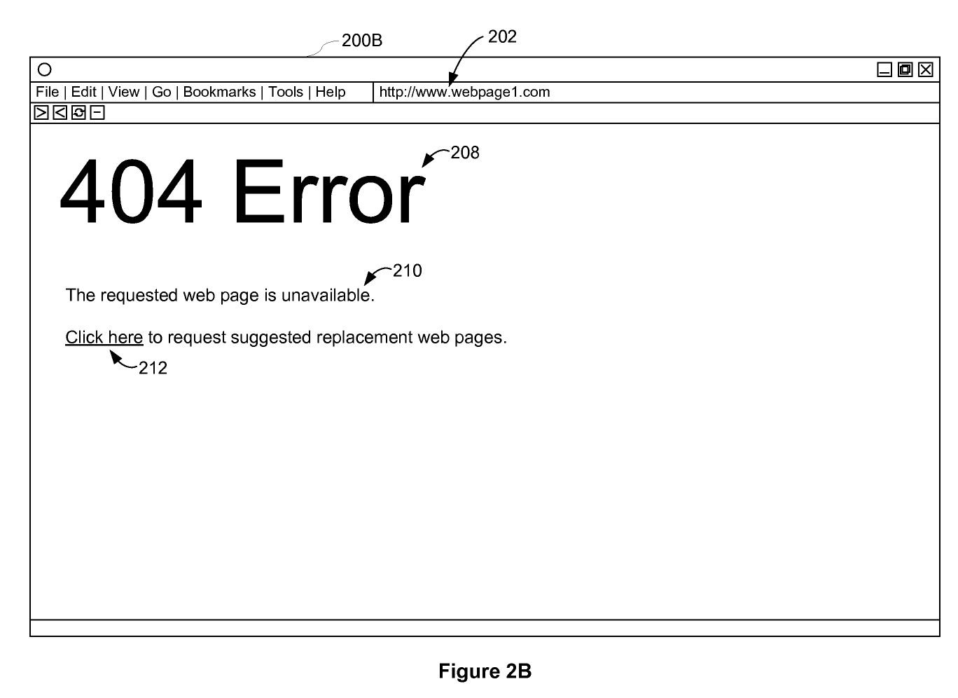

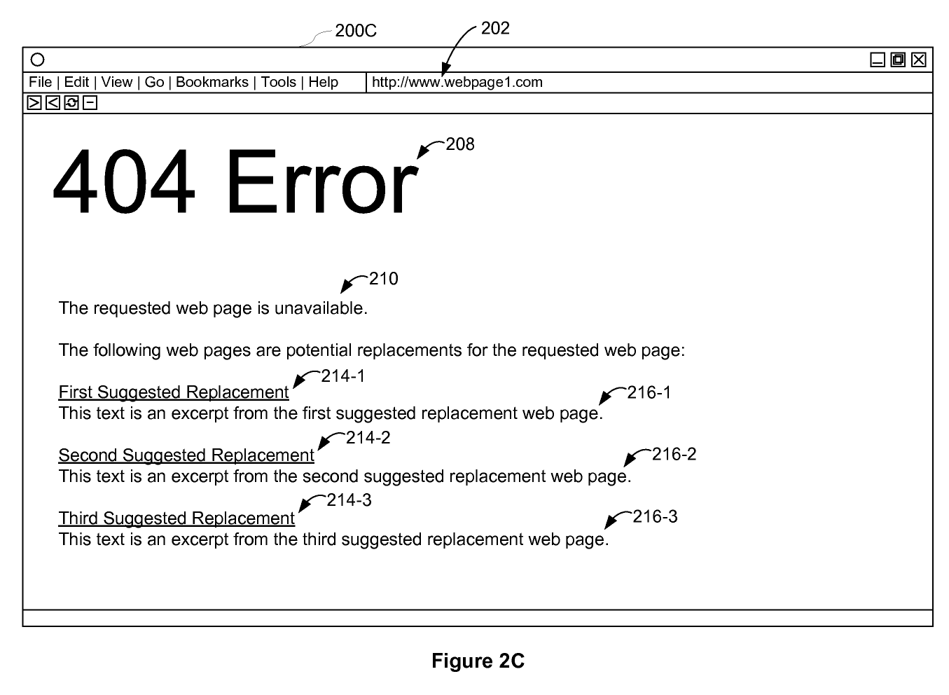

FIGS. 2A-2C are schematic screenshots of a web browser UI 200 in accordance with some embodiments. In UI 200A (FIG. 2A), a user has requested an unavailable web page with a URL 202, resulting in display of an error notification 208. In this example, the error notification 208 indicates that a 404 error has occurred. In other examples the web browser UI 200 may display similar error notifications for other types of errors, such as DNS errors, 403 errors, and timeout errors. A “request replacement page” button 204 is displayed in a toolbar 206. The user may select the button 204, for example by clicking on it with a mouse or other selection device, to generate a request for replacement web page information. In some embodiments, “request replacement page” may be an option in a drop-down menu displayed in the toolbar 206. In some embodiments, the toolbar 206 corresponds to an application that a user may install in a client system 102 to supplement the functionality of a web browser application.

In some embodiments, instead of providing a toolbar button 204, the web browser UI 200 may display a link 212 that a user may select to generate a request for replacement web page information. For example, as illustrated in UI 200B (FIG. 2B) in accordance with some embodiments, the link may be included in text 210 accompanying the error notification 208.

In some embodiments, a web browser application automatically generates a request for replacement web page information in response to a failed attempt to access a web page, without requiring user action to generate the request.

UI 200C (FIG. 2C) illustrates the display of replacement web page information in accordance with some embodiments. In some embodiments, UI 200C is displayed in response to a request generated by selecting the button 204 (FIG. 2A) or the link 212 (Figure B), or in response to a request that was automatically generated upon receipt of an error notification. The replacement web page information displayed in UI 200C includes links 214-1, 214-2, and 214-3 to web pages that have content overlaps with the unavailable web page 202 that satisfy a first criterion. In some embodiments the displayed web page information also includes snippets 216-1, 216-2, and 216-3 excerpted from the web pages corresponding to the links 214-1, 214-2, and 214-3. The user may browse to one of the replacement web pages by selecting the corresponding link 214. Because the replacement web pages have overlapping content with the unavailable web page, the user thus may access at least a portion of the content from the unavailable web page that the user had sought to access.

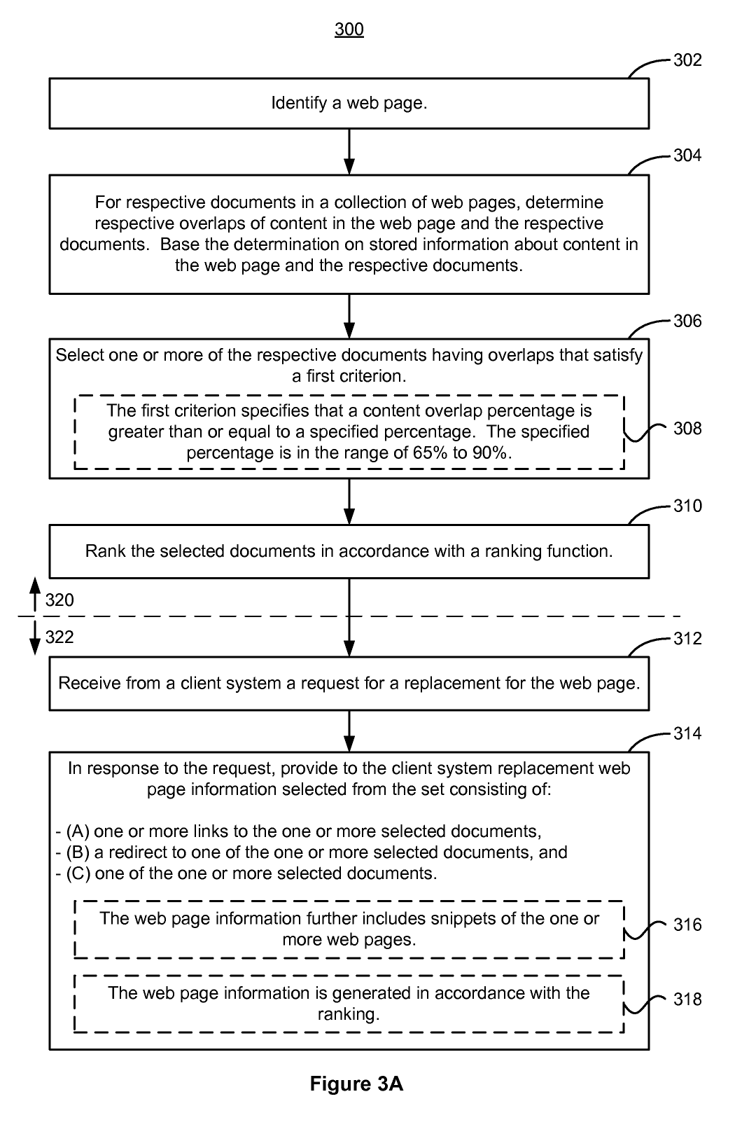

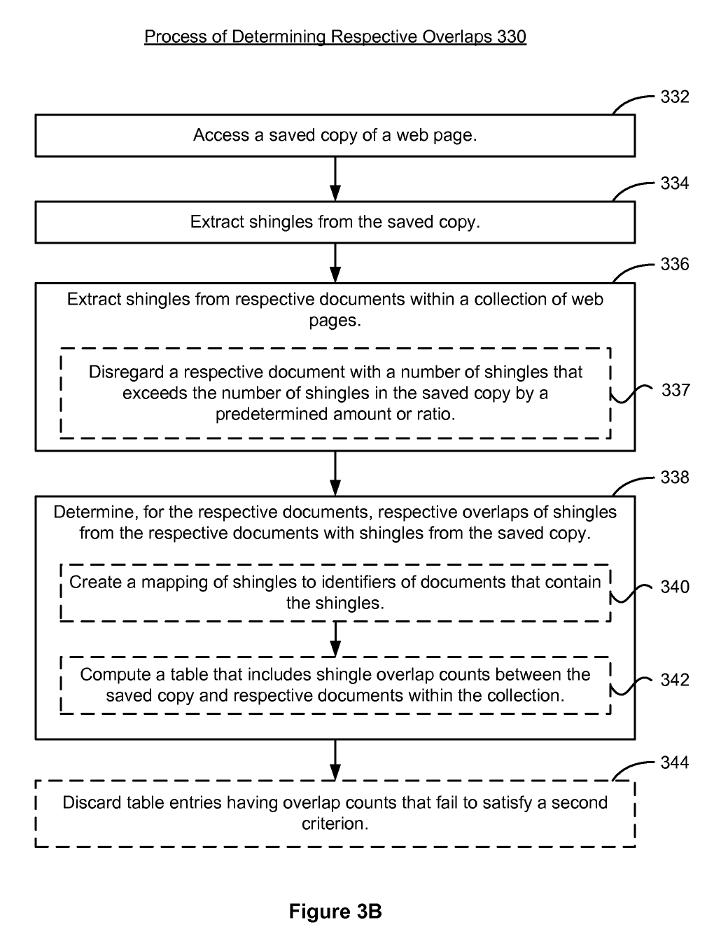

FIG. 3A is a flow diagram illustrating a method 300 of suggesting replacements for unavailable web pages in accordance with some embodiments. In some embodiments, the method 300 is performed at a web page replacement information server system 104 separate from a client system 102 (FIG. 1). In the method 300, a web page is identified (302). For example, a web page stored in a database of cached web pages 114 is identified.

For respective documents in a collection of web pages (e.g., in the database 114 or a subset thereof), respective overlaps of content in the identified web page and the respective documents are determined (304). The determination is based on stored information about content in the web page and the respective documents, such as cached copies of the web page and the respective documents.

One or more of the respective documents are selected (306) that have overlaps that satisfy a first criterion. In some embodiments the first criterion requires less than substantial similarity between a document and the identified web page: for example, the first criterion may specify that a percentage of content overlap is greater than 90%, or 70%, or 65%. Thus, in some embodiments the first criterion specifies that a document has a percentage of content overlap with the identified web page that is greater than or equal to a specified percentage. In some embodiments the specified percentage falls within a range of 80% to 90%, or 70% to 90%, or 65% to 90% (308). When determining the percentage of overlap, the denominator is (or is related to) the number of shingles in the identified document for which a replacement may be sought. Thus, two documents of different size may have the same percentage overlap with an identified document (sometimes called a target document, unavailable document, or prospective unavailable document). For this reason, the first criterion may also include a relative size limit on the potential replacement documents, such as one-hundred fifty percent (150%) or two-hundred percent (200%) (which may be measured in terms of number of shingles) of the size of the identified document, so as to exclude documents whose content is largely unrelated to the content of the identified document.

In some embodiments, the documents selected in operation 306 are ranked (310) in accordance with a ranking function. For example, the selected documents may be ranked according to their respective content overlap percentages or according to their PageRanks. Documents that have been recently crawled may be prioritized over documents with older crawl times. Documents that were not successfully fetched during a most recent crawl may be disregarded. Documents with links to the identified web page may be prioritized over documents without links, or with fewer links, to the identified web page. Documents marked as possibly containing malware or phishing applications may be deprioritized or disregarded entirely. Pornographic documents may be deprioritized or disregarded entirely if the identified web page is not pornographic.

In some embodiments, the ranking function is a function of multiple variables, such as any or all of the variables listed in the previous paragraph. For example, the ranking function may be a linear function of multiple variables, a polynomial function of multiple variables, or an exponential function of multiple variables. In some embodiments, the ranking function is a piecewise linear function of the form y=k₁f₁(x₁)+ . . . +kₙfₙ(xₙ), where the functions f(x) are discretizer functions that map ranges of values of x to the same value (e.g., f(x)=−1 if x is less than a predefined value, otherwise f(x)=1). In some embodiments, f(x)=1 if a condition is true and f(x)=−1 (or f(x)=0) if a condition is false. In some embodiments, the ranking function is a sigmoid function; in some embodiments, the inputs to the sigmoid function are discretized.

A request is received (312) from a client system (e.g., 102, FIG. 1) for a replacement for the identified web page. In some embodiments, the client system generated the request in response to a user action (e.g., selecting a button 204 or a link 212, FIGS. 2A-2B). In some embodiments, the client system automatically generates the request, without user action, upon receipt at the client system of a predefined error (e.g., upon receiving notification of a known error type) in response to a request for the web page. In some embodiments, the request specifies the type of error notification received in response to a failed request for the identified web page.

In response to the request, replacement web page information is provided (314) to the client system. The replacement web page information is selected from the set consisting of: (A) one or more links (e.g., 214, FIG. 2C) to the one or more selected documents, (B) a redirect to one of the one or more selected documents, and (C) one of the one or more selected documents. In some embodiments, the replacement web page information further includes (316) snippets (e.g., 216, FIG. 2C) of the one or more web pages.

In some embodiments, the web page information provided to the client system is generated (316) in accordance with the ranking performed in operation 310. For example, links provided to the client system are ordered according to the rankings of their corresponding documents. In another example, the document provided to the client system or for which a redirect is provided is the highest ranked document.

While the method 300 includes a number of operations that appear to occur in a specific order, it should be apparent that the method 300 can include more or fewer operations, an order of two or more operations may be changed, and/or two or more operations may be combined into a single operation. With regard to the order of operations, the method 300 is divided into two phases. A first phase 320 is performed prior to and independently of receiving a request for a replacement web page. Operations in the first phase 320 may be performed repeatedly. For example, the first phase 320 may be performed each time a web crawler application completes a crawl of the web or a portion of the web. In some embodiments, the first phase 320 is performed repeatedly for successive documents in the database 114. A second phase 322 includes receipt of the request (322) and operations performed in response to the request. FIG. 3A shows that the ranking operation 310 is performed as part of the first phase 320. In some embodiments, however, the ranking operation 310 is performed in the second phase 322 in response to receipt of the request (312). In some embodiments, selection of documents (306) is performed in response to receipt of the request (312). For example, upon receipt of a request (312), the server system 104 may query the document overlap database 112 to select documents with overlaps that satisfy the first criterion (306). In some embodiments, both operations 306 and 310 are performed in the second phase 322; in some other embodiments, ranking 310 is performed in the first phase 320 and selection 306 is performed in the second phase 322.

In some embodiments in which the ranking operation 310 is performed in the second phase 322 in response to receipt of the request (312), the ranking function considers the type of error notification received in response to a failed request for the identified web page. In some embodiments, if a DNS error occurred, the ranking function disregards any selected documents that are stored on the same host 130 (i.e., on a common host) as the identified web page. Because the DNS error indicates that the common host 130 is inaccessible, other documents stored on that host also will be inaccessible and thus should be disregarded. In some embodiments, if a 404 error occurred, selected documents that are stored on the common host 130 are prioritized over selected documents stored on other servers, based on the assumption that a document stored on a common host 130 as the unavailable web page is potentially more likely to be of interest to the user than documents stored on other hosts 130. In some embodiments, the type of error is one of multiple factors and/or variables considered by the ranking function.

In some embodiments, determination (304) of content overlaps between the identified web page and the respective documents involves shingling. Shingles are sequences of a fixed number of words found in one or more documents in a collection of documents. A shingle thus is a k-tuple of words, where k is a fixed integer. In some embodiments, k is chosen to be large enough that two different documents are unlikely to contain the same shingle. In some embodiments, k=6, corresponding to shingles of six consecutive words in a document.

Shingling a document refers to identifying and extracting shingles from the document. For example, if a document consists of the text, “The quick brown fox jumps over the lazy dog” and k=6, four shingles may be extracted from the document:
the quick brown fox jumps over
quick brown fox jumps over the
brown fox jumps over the lazy
fox jumps over the lazy dog

FIG. 3B is a flow diagram illustrating a method 330 of using shingling to determine content overlaps in accordance with some embodiments. The method 330 represents a possible implementation of the determining operation 304 of method 300 (FIG. 3A). In the method 330, a saved copy of a web page is accessed (332). For example, a cached copy of a web page is accessed from the database 114 (FIG. 1). Shingles are extracted (334) from the saved copy. Shingles also are extracted (336) from respective documents within a collection of web pages (e.g., from other cached copies of web pages in the database 114). In some embodiments, a respective document is disregarded (337) if its number of shingles exceeds the number of shingles in the saved copy by a predetermined amount or ratio. For example, a respective document is disregarded if it has 50% more shingles than the saved copy, or if it has twice as many shingles as the saved copy.

Respective overlaps are determined (338) of shingles from the respective documents with shingles from the saved copy. In some embodiments, an absolute overlap (i.e., a count of overlapping shingles) is determined. In some embodiments, a relative shingle overlap is determined, defined as the ratio of the count of overlapping shingles to the number of shingles in the saved copy of the web page or in a respective document.

In some embodiments, determining the respective overlaps includes creating (340) a mapping of shingles to identifiers of documents that contain the shingles. In some embodiments, the identifiers are URLs or combinations of URLs and timestamps. In some embodiments, the timestamps correspond to a time at which a web crawler crawled the document. Examples of mappings of shingles to identifiers of documents that contain the shingles are described below with regard to FIGS. 5A and 5B.

In some embodiments, determining the respective overlaps includes computing (342) a table containing shingle overlap values for the saved copy and respective documents within the collection of web pages. An example of a table containing shingle overlap values is described below with regard to FIG. 5C. In some embodiments, table entries are discarded (344) if their overlap counts fail to satisfy a second criterion. For example, table entries may be discarded if their absolute overlaps, relative overlaps, or both are less than specified values. In one example, table entries are discarded if either their absolute overlaps are less than 20 shingles or their relative overlaps are less than 80% (e.g., if less than 80% of the shingles in a target document are found in another document, the entry for that pair of documents is discarded).

In some embodiments, shingling also may be used in ranking respective documents (e.g., in operation 310, FIG. 3A). For example, the ranking function may prioritize documents having high absolute overlap (i.e., a high count of overlapping shingles) with a web page or high relative overlap with the web page, where the relative overlap is defined either based on the total number of shingles in the web page or the total number of shingles in the document being ranked. In some embodiments, the ranking function considers how many consecutive shingles from the web page are also found consecutively in respective documents being ranked and prioritizes documents having high numbers of consecutive overlapping shingles.

The method 330 provides an efficient process for determining content overlap. In some embodiments in which the method 330 is used in conjunction with the method 300 to determine (304) content overlap and then select (306) documents with overlaps that satisfy a first criterion, the first criterion specifies that a relative overlap of shingles between a respective document and the saved copy exceeds a predefined percentage. In some embodiments, the predefined percentage is greater than or equal to 65%, or 70%, or 80%. In some embodiments, the predefined percentage is less than or equal to 90%. The predefined percentage thus may fall within a range of 65% to 90%, for example, or of 70% to 90%, or of 80% to 90%. In some embodiments, the first criterion specifies that an absolute overlap of shingles between a respective document and the saved copy exceeds a predefined count.

In some embodiments, a method analogous to the method 330 may be implemented using other types of text fragments instead of shingles, such as sentences or fixed amounts of letters. In some embodiments, fingerprints for the text fragments are calculated and compared to determine content overlaps, instead of comparing the text fragments themselves.

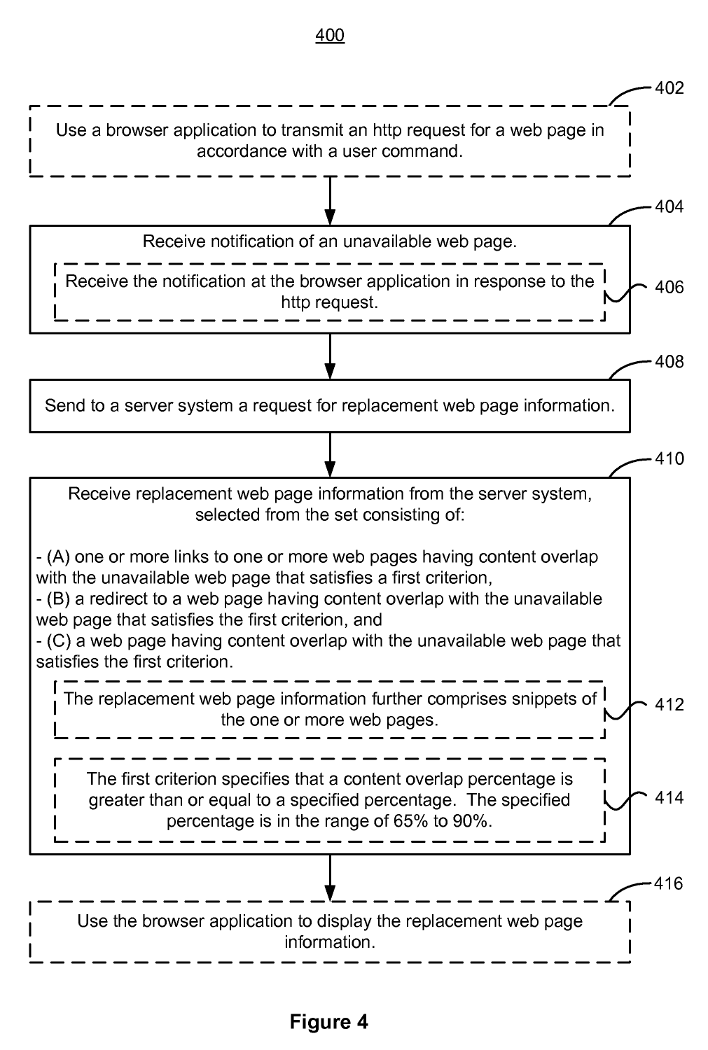

FIG. 4 is a flow diagram illustrating a method 400 of suggesting replacements for unavailable web pages in accordance with some embodiments. In some embodiments, the method 300 is performed at a client system 102 separate from a web page replacement information server system 104 (FIG. 1).

In some embodiments of the method 400, a browser application is used to transmit (402) an http request for a web page (e.g., to a host 130) in accordance with a user command.

Notification is received (404) of an unavailable web page. In some embodiments, the notification is received (406) at the browser application in response to the http request.

A request for replacement web information is sent (408) to a server system (e.g., server system 104). In some embodiments, the request is sent automatically, without user action, upon receiving notification of the unavailable web page. Alternatively, the request is sent in response to a user action (e.g., selection of a button 204 or a link 212, FIGS. 2A-2B).

Replacement web page information is received (410) for the server system. The replacement web page information is selected from the set consisting of: (A) one or more links (e.g., 214, FIG. 2C) to one or more web pages having content overlap with the unavailable web page that satisfies a first criterion, (B) a redirect to a web page having content overlap with the unavailable web page that satisfies the first criterion, and (C) a web page having content overlap with the unavailable web page that satisfies the first criterion. Examples of the first criterion are described above with regard to operation 306 of method 300 (FIG. 3A). In some embodiments, the replacement web page information further includes (412) snippets (e.g., 216, FIG. 2C) of the one or more web pages.

In some embodiments, the replacement web page information corresponds to one or more web pages with shingles that overlap with shingles in the unavailable web page by at least a first predefine amount. In some embodiments, the first predefined amount is a predefined percentage of relative overlap of shingles. Exemplary values for the predefined percentage of relative overlap are discussed with regard to methods 300 and 330 (FIGS. 3A-3B). In some embodiments, the first predefined amount is a predefined count of shingles.

In some embodiments, the web page or pages corresponding to the replacement web page information have numbers of shingles that are less than or equal to a second predefined amount that is a function of the number of shingles in the unavailable web page. For example, the web page or pages have numbers of shingles that are less than 1.5 times the number of shingles in the unavailable web page or less than two times the number of shingles in the unavailable web page.

In some embodiments, the one or more links are ranked in accordance with a ranking function applied to their corresponding web pages, as described with regard to method 300 (FIG. 3A).

The browser application displays (416) the replacement web page information, thus enabling the user to access at least a portion of the content of the unavailable web page.

FIGS. 5A-5C are diagrams illustrating data structures for web page shingling in accordance with some embodiments. FIGS. 5A and 5B illustrate respective shingle mapping tables 500 and 520, which may be generated as described in operation 340 of method 330 (FIG. 3B) in accordance with some embodiments. Each row 502 in a table 500 or 520 lists a distinct shingle 504 found in at least one document in a collection of documents, along with identifiers of all the documents in the collection that include the shingle 504. In the table 500 the identifiers are URLs 506 of web pages; in the table 520 the identifiers are pairs 526 of URLs and timestamps. In some embodiments, the timestamps correspond to times when respective web pages were fetched into the collection of documents (e.g., when the web pages were crawled). Including timestamps in the identifiers allows the collection to include multiple copies of a web page that were fetched at different times. In some embodiments, a table 500 or 520 includes the position (not shown) of each shingle 504 within corresponding documents as identified by identifiers 506 or 526. Positional information may be used to calculate counts of consecutive overlapping shingles.

In some embodiments a table 500 or 520 stores a fingerprint of a shingle 504 (e.g., calculated using a hash function) instead of or in addition to the shingle 504.

FIG. 5C illustrates a table of shingle overlaps 540 in accordance with some embodiments. In some embodiments, the table of shingle overlaps 540 is generated as described in operation 342 of method 330 (FIG. 3B). Each row 542 corresponds to a pair of documents in the collection of documents. The documents are identified by URLs 506, or alternately, by pairs of URLs and timestamps (not shown). In addition to the identifiers, each row 542 includes one or more measures of content overlap between the documents in the pair, such as a shingle overlap count 544 and a relative shingle overlap 546, defined as the ratio of the shingle overlap count 544 to the number of shingles in one of the documents in the pair. The shingle overlap counts 544 may be generated from the table 500 by counting, for a respective URL 506 (e.g., 506-1A), the number of rows 502 in which another URL 506 (e.g., 506-1B or 506-1C) also is listed. In some embodiments, a respective row 542 includes a ranking 548, which may be calculated as described for operation 310 (FIG. 3A). In some embodiments, a respective row 542 only includes a ranking if the first criterion is satisfied. In some embodiments, a respective row 542 includes a selection flag 550 to indicate whether a measure of content overlap for the pair satisfies the first criterion. In some embodiments, a respective row 542 includes additional fields, such as a count of consecutive overlapping shingles (not shown).

In some embodiments, the tables 540 and 500 or 520 are stored in the document overlap database 112 of the server system 104 (FIG. 1). The replacement web page server 110 queries the table 540 to identify documents that have overlapping content with an unavailable web page.

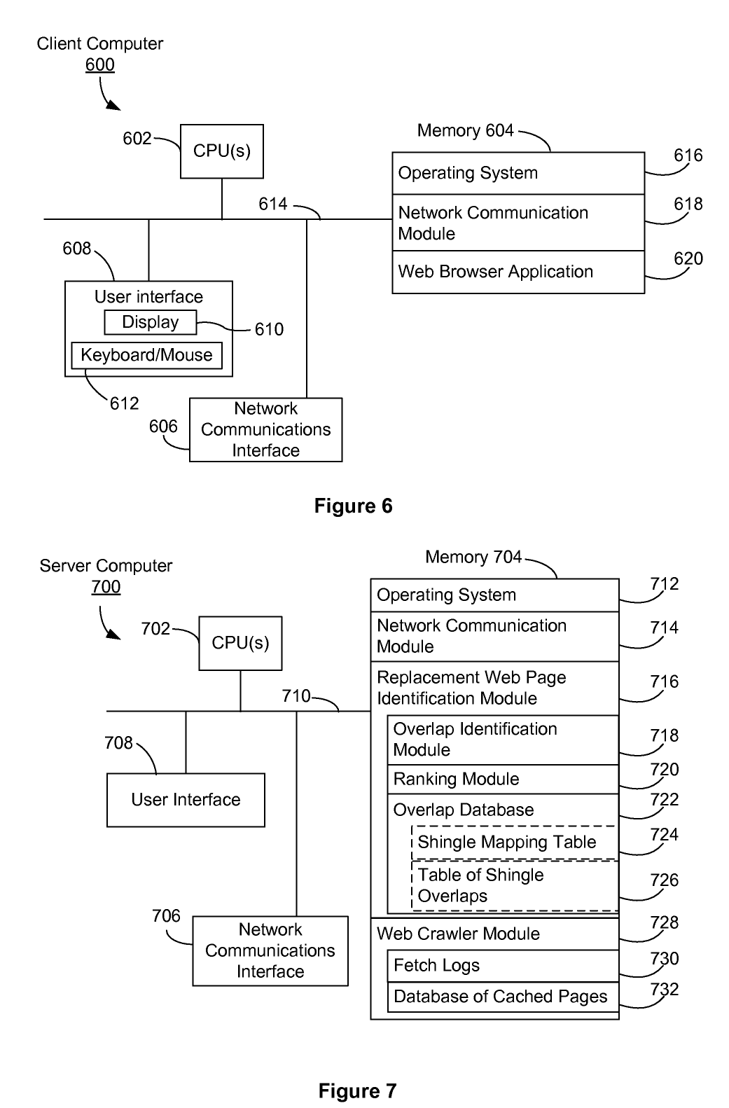

FIG. 6 is a block diagram illustrating a client computer 600 in accordance with some embodiments. The client computer 600, which in some embodiments is an exemplary implementation of a client system 102 (FIG. 1), typically includes one or more processing units (CPU's) 602, one or more network or other communications interfaces 606, memory 604, and one or more communication buses 614 for interconnecting these components. The communication buses 614 may include circuitry (sometimes called a chipset) that interconnects and controls communications between system components. The client computer 600 may also include a user interface 608 comprising, for example, a display device 610 and one or more user input devices such as a keyboard and/or mouse (or other pointing device) 612. Memory 604 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 604 may optionally include one or more storage devices remotely located from the CPU(s) 602. Memory 604, or alternately the non-volatile memory device(s) within memory 604, comprises a computer readable storage medium. In some embodiments, memory 604 stores the following programs, modules and data structures, or a subset thereof:
an operating system 616 that includes procedures for handling various basic system services and for performing hardware dependent tasks;
a network communication module 618 that is used for connecting the client system 600 to other computers via the one or more communication network interfaces 606 and one or more communication networks, such as the Internet, other wide area networks, local area networks, metropolitan area networks, and so on; and
a web browser application 620.
   In some embodiments, received web page replacement information may be cached locally in memory 604 for display by the web browser application 620.

Each of the above identified elements in FIG. 6 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 604 may store a subset of the modules and data structures identified above. Furthermore, memory 604 may store additional modules and data structures not described above.

FIG. 7 is a block diagram illustrating a server computer 700 in accordance with some embodiments. The server computer 700, which in some embodiments is an exemplary implementation of a server system 104 (FIG. 1) typically includes one or more processing units (CPU's) 702, one or more network or other communications interfaces 706, memory 704, and one or more communication buses 710 for interconnecting these components. The communication buses 710 may include circuitry (sometimes called a chipset) that interconnects and controls communications between system components. The server computer 700 optionally may include a user interface 708, which may include a display device (not shown), and a keyboard and/or a mouse (not shown). Memory 704 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 704 may optionally include one or more storage devices remotely located from the CPU(s) 702. Memory 704, or alternately the non-volatile memory device(s) within memory 704, comprises a computer readable storage medium. In some embodiments, memory 704 stores the following programs, modules and data structures, or a subset thereof:
an operating system 712 that includes procedures for handling various basic system services and for performing hardware dependent tasks;
a network communication module 714 that is used for connecting the server system 700 to other computers via the one or more communication network interfaces 706 and one or more communication networks, such as the Internet, other wide area networks, local area networks, metropolitan area networks, and so on;
a replacement web page identification module 716 for providing web page replacement information in response to requests from client systems; and
a web crawler module 728 for fetching copies of web pages.

In some embodiments, the replacement web page identification module 716 includes an overlap identification module 718 for identifying web pages with overlapping content, a ranking module 720 for ranking identified pages, and an overlap database 722. In some embodiments, the overlap database 722 includes a shingle mapping table 724 and a table of shingle overlaps 726, examples of which are described above. In some embodiments, the web crawler module 728 includes fetch logs 730 and a database of cached pages 732.

Each of the above identified elements in FIG. 7 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 704 may store a subset of the modules and data structures identified above. Furthermore, memory 704 may store additional modules and data structures not described above.

Although FIG. 7 shows a “server computer,” FIG. 7 is intended more as a functional description of the various features which may be present in a set of servers than as a structural schematic of the embodiments described herein. In practice, and as recognized by those of ordinary skill in the art, items shown separately could be combined and some items could be separated. For example, some items shown separately in FIG. 7 could be implemented on single servers and single items could be implemented by one or more servers. The actual number of servers used to implement the system of FIG. 7 and how features are allocated among them will vary from one implementation to another, and may depend in part on the amount of data stored (e.g., in the cached pages database 732 and overlap database 722) and the amount of data traffic that the system must handle during peak usage periods as well as during average usage periods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method of suggesting replacements for unavailable web pages, comprising:
at a server system separate from a client system:
identifying a web page;
determining, for respective documents in a collection of web pages, respective overlaps of content in the web page and the respective documents;
selecting one or more of the respective documents having overlaps that satisfy a first criterion;
receiving from the client system a request for replacement web page information for the web page, wherein the request identifies the web page and identifies a type of error notification received by the client system in response to a prior request for the web page; and
in response to the request, providing to the client system replacement web page information comprising one or more links to at least a subset of the one or more selected documents;
wherein the identifying, determining and selecting are performed prior to the receiving.

2. The method of claim 1, wherein the first criterion specifies that a content overlap percentage is greater than or equal to a specified percentage, the specified percentage being greater than or equal to 65% and less than or equal to 90%.

3. The method of claim 1, wherein the request from the client system is automatically generated by the client system, without user action, upon receipt at the client system of a predefined error in response to a request for the web page.

4. The method of claim 1, wherein the replacement web page information further includes snippets of the one or more web pages.

5. The method of claim 1, wherein determining respective overlaps of content in the web page and the respective documents comprises:
accessing a saved copy of the web page;
extracting fixed length shingles from the saved copy;
extracting fixed length shingles from respective documents within the collection of web pages; and
determining, for the respective documents, respective overlaps of the fixed length shingles from the respective documents with the fixed length shingles from the saved copy.

6. The method of claim 5, wherein the first criterion specifies that a relative overlap of fixed length shingles between a respective document and the saved copy exceeds a predefined percentage.

7. The method of claim 6, wherein the predefined percentage is less than or equal to 90% and greater than or equal to 65%.

8. The method of claim 5, wherein the first criterion specifies that an absolute overlap of fixed length shingles between a respective document and the saved copy exceeds a predefined count.

9. The method of claim 5, wherein determining the respective overlaps of fixed length shingles comprises:
creating a mapping of fixed length shingles to identifiers of documents that contain the fixed length shingles; and
computing a table that includes fixed length shingle overlap counts between the saved copy and respective documents within the collection.

10. The method of claim 9, further comprising discarding table entries having fixed length shingle overlap counts that fail to satisfy a second criterion.

11. The method of claim 9, wherein the identifiers are uniform resource locators (URLs).

12. The method of claim 9, wherein the identifiers comprise a combination of URLs and timestamps.

13. The method of claim 5, wherein the saved copy has a number of fixed length shingles, further comprising disregarding a respective document having a number of fixed length shingles that exceeds the number of fixed length shingles in the saved copy by a predetermined amount or ratio.

14. (canceled)

15. A method of suggesting replacements for unavailable web pages, comprising:
at a server system separate from a client system:
prior to receiving from the client system a request for replacement web page information for a web page:
identifying the web page;
determining, for respective documents in a collection of web pages, respective overlaps of content in the web page and the respective documents; and
selecting one or more of the respective documents having overlaps that satisfy a first criterion;
receiving from the client system the request for the replacement web page information for the web page, wherein the request identifies the web page and identifies a type of error notification received by the client system in response to a prior request for the web page; and
in response to the request:
ranking the selected documents in accordance with a ranking function, and generating the replacement web page information in accordance with the ranking of the selected documents, wherein ranking the selected documents comprises:
determining whether said prior request for the web page resulted in a DNS error; and
in accordance with a determination that said prior request for the web page resulted in a DNS error, disregarding any documents of the selected one or more documents that are stored on a common host as the web page, and retaining one or more documents of the selected document not stored on the common host; and
providing to the client system replacement web page information comprising one or more links to at least a subset of the one or more selected documents.

16. The method of claim 15, further comprising:
determining whether said prior request for the web page resulted in a 404 error; and
in accordance with a determination that said prior request for the web page resulted in a 404 error, prioritizing selected documents stored on a common host as the web page.

17. The method of claim 15, wherein the ranking function prioritizes a selected document having a high PageRank over an otherwise equivalent selected document having a lower PageRank.

18. The method of claim 15, wherein the ranking function prioritizes a selected document having a recent crawl time over an otherwise equivalent selected document having an older crawl time.

19. The method of claim 15, wherein the ranking function prioritizes selected documents having links to the web page.

20. A server system, comprising:
one or more processors; and
memory storing one or more programs to be executed by the one or more processors, the one or more programs comprising:
instructions to identify a web page;
instructions to determine, for respective documents in a collection of web pages, respective overlaps of content in the web page and the respective documents;
instructions to select one or more of the respective documents having overlaps that satisfy a first criterion;
instructions to receive from the client system a request for replacement web page information for the web page, wherein the request identifies the web page and identifies a type of error notification received by the client system in response to a prior request for the web page; and
instructions to provide to the client system, in response to the request, replacement web page information comprising one or more links to at least a subset of the one or more selected documents;
wherein the identifying, determining, and selecting are performed prior to the receiving.

21. A non-transitory computer readable storage medium storing one or more programs to be executed by one or more processors at a server system, the one or more programs comprising:
instructions to identify a web page;
instructions to determine, for respective documents in a collection of web pages, respective overlaps of content in the web page and the respective documents;
instructions to select one or more of the respective documents having overlaps that satisfy a first criterion;
instructions to receive from the client system request for a replacement web page information for the web page, wherein the request identifies the web page and identifies a type of error notification received by the client system in response to a prior request for the web page; and
instructions to provide to the client system, in response to the request, replacement web page information comprising one or more links to at least a subset of the one or more selected documents;
wherein the identifying, determining, and selecting are performed prior to the receiving.

22. A method of suggesting replacements for unavailable web pages, comprising:
at a client system separate from a server system:
receiving notification of an unavailable web page, wherein the notification is a DNS error notification;
sending to the server system a request for replacement web page information, wherein the request identifies the unavailable web page and identifies a type of error notification received by the client system in response to a prior request for the web page; and
receiving replacement web page information from the server system, the replacement web page information comprising one or more links to one or more web pages having content overlap with the unavailable web page that satisfies a first criterion, wherein, in accordance with a determination that the type of error notification is a DNS error notification, the replacement web information excludes information for web pages that are stored on a common host as the unavailable web page.

23. The method of claim 22, wherein the first criterion specifies that a content overlap percentage is greater than or equal to a specified percentage, the specified percentage being greater than or equal to 65% and less than or equal to 90%.

24. The method of claim 22, including:
at the client system:
executing a browser application, using the browser application to transmit a transfer protocol request for the unavailable web page in accordance with a user command, and receiving the notification at the browser application in response to the transfer protocol request; and
using the browser application, displaying the replacement web page information at the client system.

25. The method of claim 22, wherein the replacement web page information comprises the one or more links and further includes snippets of the one or more web pages.

26. The method of claim 22, wherein sending the request for replacement web page information occurs upon receiving the notification, automatically, without user action.

27. (canceled)

28. The method of claim 22, wherein the request for replacement web page information includes error information identifying an error type identified by the notification received by the client system.

29. The method of claim 22, wherein the replacement web page information corresponds to one or more web pages having fixed length shingles that overlap with fixed length shingles in the unavailable web page by at least a first predefined amount.

30. The method of claim 29, wherein the first predefined amount is a predefined percentage of relative overlap of fixed length shingles.

31. The method of claim 30, wherein the predefined percentage is less than or equal to 90% and greater than or equal to 65%.

32. The method of claim 29, wherein the first predefined amount is a predefined count of fixed length shingles.

33. The method of claim 29, wherein the one or more web pages have numbers of fixed length shingles that are less than or equal to a second predefined amount, wherein the second predefined amount is a function of the number of fixed length shingles in the unavailable web page.

34. The method of claim 22, wherein the replacement web page information corresponds to one or more web pages ranked in accordance with a ranking function.

35. The method of claim 34, wherein the one or more web pages are ranked as a function of their respective PageRanks

36. The method of claim 34, wherein the one or more web pages are ranked as a function of their respective crawl times.

37. The method of claim 34, wherein the one or more web pages are ranked as a function of their respective links to the unavailable web page.

38. The method of claim 34, wherein, when the notification is a notification of a 404 error, the one or more web pages are ranked to prioritize web pages stored on a common host as the unavailable web page.

39. A client system, comprising:
one or more processors; and
memory storing one or more programs to be executed by the one or more processors, the one or more programs comprising:
instructions to receive notification of an unavailable web page, wherein the notification is a DNS error notification;
instructions to send to a server system a request upon receiving the notification, wherein the request identifies the unavailable web page and identifies a type of error notification received by the client system in response to a prior request for the web page; and
instructions to receive replacement web page information from the server system, the replacement web page information comprising one or more links to one or more web pages having content overlap with the unavailable web page that satisfies a first criterion, wherein, in accordance with a determination that the type of error notification is a DNS error notification, the replacement web information excludes information for web pages that are stored on a common host as the unavailable web page.

40. A non-transitory computer readable storage medium storing one or more programs to be executed by one or more processors at a client system, the one or more programs comprising:
instructions to receive notification of an unavailable web page, wherein the notification is a DNS error notification;
instructions to send to a server system a request upon receiving the notification, wherein the request identifies the unavailable web page and identifies a type of error notification received by the client system in response to a prior request for the web page; and
instructions to receive replacement web page information from the server system, the replacement web page information comprising one or more links to one or more web pages having content overlap with the unavailable web page that satisfies a first criterion, wherein, in accordance with a determination that the notification is a DNS error notification, the replacement web information excludes information for web pages that are stored on a common host as the unavailable web page.

41. A server system, comprising:
one or more processors; and
memory storing one or more programs to be executed by the one or more processors, the one or more programs comprising instructions to:
prior to receiving from a client system a request for replacement web page information for a web page:
identify the web page;
determine, for respective documents in a collection of web pages, respective overlaps of content in the web page and the respective documents;
select one or more of the respective documents having overlaps that satisfy a first criterion;
receive from the client system the request for the replacement web page information for the web page, wherein the request identifies the web page and identifies a type of error notification received by the client system in response to a prior request for the web page; and
in response to the request:
rank the selected documents in accordance with a ranking function, and generating the replacement web page information in accordance with the ranking of the selected documents. wherein ranking the selected documents comprises:
determine whether said prior request for the web page resulted in a DNS error; and
in accordance with a determination that said prior request for the web page resulted in a DNS error, disregard any documents of the selected one or more documents that are stored on a common host as the web page, and retain one or more documents of the selected document not stored on the common host; and
provide to the client system replacement web page information comprising one or more links to at least a subset of the one or more selected documents.
